(19) United States
(12) Patent Application Publication
(10) Pub. No.: US 2008/0145584 A1
(43) Pub. Date: Jun. 19, 2008

(54) Multilayered composite articles

(76) Inventors: Robert B. Fish, Parkersburg, WV (US); Steven A. Mestemacher, Parkersburg, WV (US); Patricia A. Tooley, Dickson, WV (US); Kimberly Dawn Farnsworth, Walker, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/985,431

(22) Filed: Nov. 15, 2007

Related U.S. Application Data
(60) Provisional application No. 60/875,086, filed on Dec. 15, 2006.

(51) Int. Cl. B32B 1/08; B32B 27/06

(52) U.S. Cl. 428/36.91; 428/422

(57) ABSTRACT

Multilayered composite articles comprising a first layer comprising melt-extrudable perfluoropolymer, a second layer comprising a fluoropolymer derived from tetrafluoroethylene, at least one perfluorinated α-olefin; and vinylidene fluoride. The articles may be in the form of pipes, tubes, and hoses.

### CROSS REFERENCE TO RELATED APPLICATIONS

This application claims the benefit of priority to U.S. Provisional Application No. 60/875,086, filed Dec. 15, 2006.

### FIELD OF THE INVENTION

The present invention relates to multilayered composite articles, comprising fluoropolymer layers and a polyamide layer.

### BACKGROUND OF THE INVENTION

Polymeric materials are used to manufacture a vast variety of articles, in part because such materials can offer design simplicity, good physical properties, chemical resistance, temperature resistance, and/or light weight, among many other possible advantages. However, for many applications it can be difficult to find a single polymeric material that possesses all desired properties, and in such cases it may be possible to use two or more polymeric materials to prepare an article having the desired properties. For example, it is often desirable to produce articles having good chemical resistance and permeation resistance as well as strength and puncture resistance. Such articles may be, for example, in the form of pipes and tubing, such as that used to transport fluids, including hydrocarbon fluids such as crude oil and its refined products, including gasoline and other fuels.

Many fluoropolymers have good chemical resistance while many thermoplastic polyamide compositions have good physical properties such as strength and stiffness. Thus and it would be desirable to form composite articles containing fluoropolymer layers and polyamide layers. However, fluoropolymers and polyamides are typically very difficult to adhere to one another, particularly when the fluoropolymer is a perfluoropolymer. If there is little adhesion between the fluoropolymer layers and the polyamide layers, the layers may move relative to each other, which may limit the use of such articles in many applications. Thus it would be desirable to obtain a composite article comprising fluoropolymer and polyamide layers that are adhered to one another.

U.S. Pat. No. 6,524,671 discloses a coextruded laminate comprising a layer of fluoropolymer directed adhered to a layer of polyamide in the absence of any tie layer between the layers. U.S. Pat. No. 6,127,478 discloses a melt-mixed blend of polyamide and grafted fluoropolymer having polar functionality that exhibits surprisingly low permeability can bond to fluoropolymer or polyamide without an intervening layer.

EP 84088 discloses a multilayered pipe that may comprise a thin layer of poly(perfluoroethylene propylene) or poly(vinylidene fluoride), a metal foil layer for permeation resistance, an extrudable polymer layer, a pressure and temperature resistant layer made from fibers, an insulating layer, a diffusion-protection layer, and a protection layer. However, the metal foil in such pipes is susceptible to corrosion, which could lead to failure of the pipe

### SUMMARY OF THE INVENTION

There is disclosed and claimed herein a multilayered composite article, comprising:
a first layer comprising at least one melt-extrudable perfluoropolymer having a melt flow rate of at least about 20 g/10 min as measured using ASTM method D1238 at 372° C. under a 5000 g load;
a second layer that is adhered to layer (A) and that comprises at least one fluoropolymer derived from monomers comprising:
   about 20 to about 75 weight percent tetrafluoroethylene;
   about 15 to about 35 weight percent of at least one perfluorinated-olefin; and
   about 10 to about 40 weight percent of vinylidene fluoride; and
a third layer comprising a polyamide and that is adhered to layer (B).

### DETAILED DESCRIPTION OF THE INVENTION

The composite articles of the present invention are laminates comprising a layer (A) comprising a melt-extrudable perfluoropolymer, a layer (C) comprising a thermoplastic polyamide composition, and a fluoropolymer layer (B) positioned therebetween.

By “melt-extrudable” fluoropolymer is meant a fluoropolymer having a melt viscosity in the range of about 0.5×10³ to about 60×10³ Pa·s as normally measured for the particular fluoropolymer by one skilled in the art. For example, ASTM method D1238 describes methods for measuring melt flow rates for fluoropolymers. D3159 describes a method of measuring melt flow rates for tetrafluoroethylene-ethylene polymers. ASTM method D3222 describes a method of measuring melt flow for vinylidene fluoride polymers. ASTM method D5575 described a method of measuring melt flow for copolymers of vinylidene fluoride with other fluorinated monomers. As will be understood by one skilled in the art, these methods are also suitable for polymers further comprising repeat units derived from other monomers. As will be appreciated by one skilled in the art, melt flow rates may converted directly to melt viscosities.

The perfluoropolymer of layer (A) is at least one melt-extrudable perfluoropolymer. By the term “perfluoropolymer” is meant that the monovalent atoms bonded to the carbon atoms making up the polymer chain are fluorine atoms, but where, however, the end groups of the polymer need not be fluorinated.

Fluorine-containing monomers that may be used to make the melt-extrudable perfluoropolymer of layer (A) include perfluoroolefins containing 2 to 8 carbon atoms and perfluorinated vinyl ethers of the formula CF₂═CFOR or CF₂═CFOR′OR, where R and R′ may be the same or different and are perfluorinated linear or branched alkyl and alkylene groups containing 1 to 8 carbon atoms. Preferred R groups contain 1 to 4 carbon atoms. Preferred R′ groups contain 2 to 4 carbon atoms.

Examples of fluorine-containing monomers include tetrafluoroethylene (TFE), perfluoro(propyl vinyl ether) (PPVE), perfluoro(ethyl vinyl ether) (PEVE), hexafluoroisobutylene (HFIB), and hexafluoropropylene (HFP), perfluoro(butyl ethylene) (PFBE) and the like.

Preferred perfluoropolymers used in layer (A) include one or more copolymers derived from TFE and HFP; TFE, HFP, and PPVE; and TFE, HFP, and PEVE.

The perfluoropolymers used in layer (A) are usually partially crystalline as indicated by a non-zero heat of fusion associated with a melting endotherm as measured by DSC (differential scanning calorimetry) on first melting, and are considered to be fluoroplastics rather than fluoroelastomers.

The melt-extrudable perfluoropolymer used in layer (A) have a melt flow rates (MFR) of at least about 20 g/10 min, or preferably of at least about 25 g/10 min, or more preferably of at least about 30 g/10 min, as measured using ASTM method D1238 at 372° C. under a 5000 g load.

The fluoropolymer of layer (B) is at least one melt-extrudable fluoropolymer that is derived from monomers comprising (i) about 20 to about 75 weight percent tetrafluoroethylene; (ii) about 15 to about 35 weight percent of at least one perfluorinated α-olefin; and (iii) about 10 to about 40 weight percent of vinylidene fluoride. The fluoropolymer is preferably derived from monomers comprising (i) about 55 to about 75 weight percent tetrafluoroethylene; (ii) about 15 to about 20 weight percent of at least one perfluorinated α-olefin; and (iii) about 10 to about 30 weight percent of vinylidene fluoride. Preferred α-olefins have 3 to 8 carbon atoms and hexafluoropropylene is particularly preferred.

The fluoropolymer of layer (B) may be further derived from up to about 10 weight percent. (and preferably about 0.1 to about 10 weight percent) of one or more perfluorinated vinyl ethers of the formula CF₂═CFOR or CF₂═CFOR′OR, where R and R′ may be the same or different and are perfluorinated linear or branched alkyl and alkylene groups containing 1 to 8 carbon atoms. Preferred R groups contain 1 to 4 carbon atoms. Preferred R′ groups contain 2 to 4 carbon atoms. Preferred vinyl ethers include perfluoro(propyl vinyl ether) and perfluoro(ethyl vinyl ether). In one embodiment of the invention, the fluoropolymer of layer (B) is preferably not cross-linked.

The polyamide used in layer (C) may be a single polyamide or comprise a blend of two or more polyamides. In one embodiment of the invention, the polyamides preferably have sufficiently high melt-strength, melt viscosity, and melt elasticity to allow then to be extruded into pipes and other articles.

Suitable polyamides can be condensation products of dicarboxylic acids or their derivatives and diamines, and/or aminocarboxylic acids, and/or ring-opening polymerization products of lactams. Suitable dicarboxylic acids include, adipic acid, azelaic acid, sebacic acid, dodecanedioic acid, isophthalic acid and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable lactams include caprolactam and laurolactam. The monomers may be derived from bio-based sources. Preferred bio-based monomers are sebacic acid and 11-aminododecanoic acid.

Suitable polyamides include aliphatic polyamides such as polyamide 6; polyamide 6,6; polyamide 4,6; polyamide 6,9; polyamide 6,10; polyamide 6,12; polyamide 10,10; polyamide 11; polyamide 12; semi-aromatic polyamides such as poly(m-xylylene adipamide) (polyamide MXD, 6), poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene isophthalamide and hexamethylene adipamide (polyamide 6,I/6,6); the polyamide of hexamethylene terephthalamide, hexamethylene isophthalamide, and hexamethylene adipamide (polyamide 6,T/6,I6,6) and copolymers and mixtures of these polymers.

Examples of suitable aliphatic polyamides include polyamide 6,6/6 copolymer; polyamide 6,6/6,8 copolymer; polyamide 6,6/6,10 copolymer; polyamide 6,6/6,12 copolymer; polyamide 6,6/10 copolymer; polyamide 6,6/12 copolymer; polyamide 6/6,8 copolymer; polyamide 6/6,10 copolymer; polyamide 6/6,12 copolymer; polyamide 6/10 copolymer; polyamide 6/12 copolymer; polyamide 6/6,6/6,10 terpolymer; polyamide 6/6,6/6,9 terpolymer; polyamide 6/6,6/11 terpolymer; polyamide 6/6,6/12 terpolymer; polyamide 6/6,10/11 terpolymer; polyamide 6/6,10/12 terpolymer; and polyamide 6/6,6/PACM (bis-p-{aminocyclohexyl} methane) terpolymer.

Preferred polyamides include polyamide 6,6; polyamide 6,12; polyamide 6,10; polyamide 11; polyamide 12; copolyamides of hexamethylenediamine, dodecanedioic acid, and decanoic acid (polyamide 6,12/6,10); copolyamides of hexamethylenediamine, dodecanedioic acid, and terephthalic acid (polyamide 6,12/6,T); copolyamides of hexamethylenediamine, decanedioic acid, and terephthalic acid (polyamide 6,10/6,T); copolyamides of hexamethylenediamine, adipic acid, and terephthalic acid (polyamide 6,6/6,T); and copolymers thereof.

The polyamide of layer (C) may be in the form of a polyamide composition. The polyamide composition may comprise additives such as plasticizers, heat stabilizers (including copper halide based heat stabilizers and organic heat stabilizers (including hindered phenol stabilizers and phosphorous-based stabilizers), lubricants and mold-release aids, nanofillers (such as nanoclays), antioxidants, UV stabilizers, colorants, impact modifiers, conductive and static dissipative agents, coupling and cross-linking agents, fillers, and the like. A preferred polyamide composition comprises one or more plasticizers. Examples of suitable plasticizers include among others sulfonamides, preferably aromatic sulfonamides such as benzenesulfonamides and toluenesulfonamides. Examples of suitable sulfonamides include N-alkyl benzenesulfonamides and toluenesufonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide. N-Butylbenzenesulfonamide is preferred. When the polyamide is polyamide 6,12/6,10, the plasticizer is preferably present in about 6 to about 14 weight percent, based on the total weight of the polyamide and the plasticizer.

The polyamide composition is made by melt-blending the components using any method known in the art, such as an extruder or kneader. The composition may be prepared in a separate step before it is used to prepare the articles of the present invention, or the composition may be prepared by melt-blending two or more components in any suitable apparatus, such as an extruder, to form a melt that may be used directly to form the articles of the present invention without an intervening solidification step.

The articles may comprise additional layers, such as additional polymeric layers, metal layers, and reinforcing agent (such as fibers) layers.

In one embodiment of the invention, the article comprises a reinforcing fiber layer. Examples of reinforcing fibers include para-aramid fibers, carbon fibers, polyester fibers, glass fibers, and metal fibers. The fibers preferably have an initial modulus of at least about 200 grams/denier or more preferably at least about 300 grams/denier. The initial modulus is defined in ASTM D2101-1985.

As used herein, “aramid” is meant a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material can be blended with the aramid or that copolymers can be used having as much as about 10 percent of other diamine substituted for the diamine of the aramid or as much as about 10 percent of other diacid chloride substituted for the diacid chloride of the aramid.

Methods for making para-aramid fibers useful in this invention are generally disclosed in, for example, U.S. Pat. Nos. 3,869,430; 3,869,429; and 3,767,756. Such aromatic polyamide organic fibers and various forms of these fibers are available from E.I. DuPont de Nemours & Co., Wilmington, Del. under the trademark Kevlar® fibers. Preferred para-aramid fibers include poly(paraphenylene terephthalamide) fibers. A preferred Kevlar® fiber includes Kevlar® 29 fiber.

The multilayered articles may be assembled by any method known to those skilled in the art. For example, the materials of one or more layers may be coextruded to form a multilayered structure. Additional layers may be subsequently added to the structure.

Parts of extruders used to handle molten fluoropolymers of layers (A) and (B) may need to be constructed from special metal alloys to minimize corrosion during processing. Preferred materials are high nickel alloys, such those sold under the trademark Hastelloy® by Haynes International, Kokomo, Ind.

The articles may be in the form of coextruded articles, shaped articles, blow molded articles, films, sheets, and the like. The articles may be in the form of shaped articles used for handling and storing fuel fluids and/or other chemicals.

In a preferred embodiment, the articles of the present invention are in the form of pipes, tubes, or hoses. The pipes, tubes and hoses are useful in a variety of applications, including those that require good chemical resistance. Suitable applications include fuel lines (including automotive fuel lines), district heating pipes, components of undersea flex pipes or marine umbilicals, and chemical transport pipes in industrial settings such chemical processes. The pipes and tubes may be used to transport crude oil, natural gas, and refined petroleum products.

### EXAMPLES

Multilayered articles comprising perfluoropolymer layer (A), fluoropolymer layer (B), and optionally polyamide layer (C) are prepared and the adhesion strength between layers (A) and (B) is determined. Each layer is formed separately from the materials indicated in Table 1 and laminated together to form the multilayered articles.

The perfluoropolymer layers (A) and fluoropolymer layers (B) are prepared by compression molding using a hydraulic bench press, Model P-21 available from Pasadena Hydraulic Inc., El Monte, Calif. Compression molding involves a sequence of steps where the material is subjected to pressure at a set temperature. Following a hot molding step, the sample is immediately removed from the hot press and placed in a “cold” press (same model as above but with no temperature control) for cooling.

In case of perfluoropolymer layers (A), about 63 g of perfluoropolymer was molded into a 6 in×6 in sample having a thickness of about 60 mils. In case of fluoropolymer layers (B), about 9 g of fluoropolymer was molded into a 4 in×4 in sample having a thickness of about 7 mils.

In each case, the polymer is held at 300° C. at atmospheric pressure for 4 minutes and then held at 300° C. under a pressure of 20,000 lbf (which corresponds to about 555 psi for layers (A) and about 1250 psi for layers (B)) for 1 minute. The sample is then moved to a press at room temperature and held under a pressure of 20,000 lbf for 5 minutes.

The polyamide layer (C) is prepared by injection molding the polyamide into a 5 in×5 in plaque weighing about 34 g.

After each of the individual layers is prepared it is trimmed to be 4 in×4 in in size and the layers are laminated together. Prior to lamination, a piece of Kapton® polyimide film supplied by E.I. du Pont de Nemours & Co is placed between layers (A) and (B) such that it runs the length of one side of the laminate and extends about 0.5 in from the edge. This prevents the layers from adhering to each other in the area containing the film to allow for formation of tabs to be used for adhesion testing and is removed after the lamination process.

The two- or three-layered samples are laminated via compression molding. The layered components are held at 300° C. at atmospheric pressure for 4 minutes and then held at 300° C. under a pressure of 20,000 lbf (about 1250 psi) for 1 minute. The sample is then moved to a press at room temperature and held under a pressure of 20,000 lbf (about 1250 psi) for 5 minutes.

Upon cooling each laminated sample is cut into four strips in a direction perpendicular to the side that contained the polyimide film, each having dimensions of 1 in×4 in. Adhesion strength peel testing is then performed on each strip on an Instron® 5500R according to ASTM D 1876 to determine peel strength—interface failure on each of the four strips, The averaged results are given in Table 1.

The following materials are referred to in Table 1:

Perfluoropolymer A is Teflon® FEP 6100, a TFE/HFP/PEVE terpolymer having a melt flow rate of about 30 g/10 min.

Perfluoropolymer B is Teflon® FEP TE9494, a TFE/HFP/PEVE terpolymer having a melt flow rate of about 30 g/10 min.

Perfluoropolymer C is Teflon® FEP 100, a TFE/HFP copolymer having a melt flow rate of about 7 g/10 min.

Perfluoropolymer D is Teflon® FEP G11, a TFE/HFP/PEVE terpolymer having a melt flow rate of about 11 g/10 min.

Perfluoropolymer E is Teflon® PFA 340, a TFE/PPVE copolymer having a melt flow rate of about 13 g/10 min.

Perfluoropolymer F is Teflon® PFA 440, a TFE/PPVE copolymer having a melt flow rate of about 13 g/10 min.

Fluoropolymer A is THV 500, a TFE/HFP/vinylidene fluoride terpolymer having a melt flow rate of about 95 g/10 min supplied by Dyneon.

Fluoropolymer B is Viton® F600, a TFE/HFP/vinylidene fluoride terpolymer supplied by DuPont Performance Elastomers.

Fluoropolymer C is Viton® F605C, a TFE/HFP/vinylidene fluoride terpolymer supplied by DuPont Performance Elastomers.

Polyamide is a melt blended composition comprising about 80.4 weight percent polyamide 6,12; about 12 weight percent N-butylbenzenesulfonamide; and about 6 weight percent of a maleic anhydride grafted ethylene/propylene/diene rubber, and about 1.6 percent heat and light stabilizers.

Melt flow rates are measured using ASTM method D1238 at 372° C. under a 5000 g load.

Teflon® polymers are supplied by E.I. du Pont de Nemours & Co., Wilmington, Del.

TABLE 1

| | | Layer (A) | | | Peel test |
|---|---|---|---|---|---|
| | | approx. MFR | | | strength in |
| Sample | Layer (A) | (g/10 min) | Layer (B) | Layer (C) | Ld/W (lbf/in) |
| 1 | Perfluoropolymer | 30 | Fluoropolymer | — | 2.9 |
| | A | | A | | |
| 2 | Perfluoropolymer | 30 | Fluoropolymer | — | 2.7 |
| | B | | A | | |
| 3 | Perfluoropolymer | 7 | Fluoropolymer | — | 1.9 |
| | C | | A | | |
| 4 | Perfluoropolymer | 11 | Fluoropolymer | — | 1.8 |
| | D | | A | | |
| 5 | Perfluoropolymer | 13 | Fluoropolymer | — | 2.1 |
| | E | | A | | |
| 6 | Perfluoropolymer | 13 | Fluoropolymer | — | 2.1 |
| | F | | A | | |
| 7 | Perfluoropolymer | 30 | Fluoropolymer | Polyamide | 2.7 |
| | A | | A | | |
| 8 | Perfluoropolymer | 30 | Fluoropolymer | Polyamide | 2.7 |
| | B | | A | | |
| 9 | Perfluoropolymer | 30 | Poly(vinylidene | Polyamide | Delamination |
| | A | | fluoride) | | occurred |
| | | | | | between layers |
| | | | | | (A) and (B) |
| 10 | Perfluoropolymer | 30 | Fluoropolymer | Polyamide | 2.0 |
| | A | | B | | |
| 11 | Perfluoropolymer | 30 | Fluoropolymer | Polyamide | Delamination |
| | A | | C | | occurred |
| | | | | | between layers |
| | | | | | (A) and (B) |
| | | | | | when molded |
| | | | | | laminate was cut. |

What is claimed is:

1. A multilayered composite article, comprising:
(A) a first layer comprising at least one melt-extrudable perfluoropolymer having a melt flow rate of at least about 20 g/10 min as measured using ASTM method D1238 at 372° C. under a 5000 g load;
(B) a second layer that is adhered to layer (A) and that comprises at least one fluoropolymer derived from monomers comprising:
(i) about 20 to about 75 weight percent tetrafluoroethylene;
(ii) about 15 to about 35 weight percent of at least one perfluorinated α-olefin; and
(iii) about 10 to about 40 weight percent of vinylidene fluoride; and
(C) a third layer comprising a polyamide and that is adhered to layer (B).

2. The article of claim 1, wherein the polyamide is a polyamide composition comprising plasticizer.

3. The article of claim 2, wherein the plasticizer is one or more of N-butylbenzenesulfonamide, N-ethyl-o-toluenesulfonamide, or N-ethyl-p-toluenesulfonamide

4. The article of claim 1, wherein the polyamide is selected from the group consisting of polyamide 6,10; polyamide 6,12; polyamide 11; and polyamide 12.

5. The article of claim 1, wherein the polyamide is a polyamide composition comprising at least one copper halide heat stabilizer and/or at least one organic heat stabilizer.

6. The article of claim 1, wherein the melt-extrudable perfluoropolymer of layer (A) has a melt flow rate of at least about 25 g/10 min.

7. The article of claim 1, wherein the melt-extrudable perfluoropolymer of layer (A) has a melt flow rate of at least about 30 g/10 min.

8. The article of claim 1, wherein the melt-extrudable perfluoropolymer of layer (A) is selected from one or more of polymers of tetrafluoroethylene and hexafluoropropylene; polymers of tetrafluoroethylene, hexafluoropropylene, and perfluoro(propyl vinyl ether); and polymers of tetrafluoroethylene, hexafluoropropylene, and perfluoro(ethyl vinyl ether).

9. The article of claim 8, wherein the melt-extrudable perfluoropolymer of layer (A) is one or more polymers of tetrafluoroethylene, hexafluoropropylene, and perfluoro(ethyl vinyl ether).

10. The article of claim 1, wherein the fluoropolymer of layer (B) is derived from monomers comprising (i) about 55 to about 75 weight percent tetrafluoroethylene; (ii) about 15 to about 20 weight percent of at least one perfluorinated α-olefin; and (iii) about 10 to about 30 weight percent of vinylidene fluoride..

11. The article of claim 1, wherein the perfluorinated α-olefin (ii) is hexafluoropropylene.

12. The article of claim 1, wherein the fluoropolymer of layer (B) is further derived from up to about 10 weight percent of one or more perfluorinated vinyl ethers of the formula CF₂═CFOR or CF₂═CFOR′OR, where R and R′ may be the same or different and are perfluorinated linear or branched alkyl and alkylene groups containing 1 to 8 carbon atoms.

13. The article of claim 12, wherein the perfluorinated vinyl ether is selected from one or more of perfluoro(propyl vinyl ether) and perfluoro(ethyl vinyl ether).

14. The article of claim 1 further comprising a layer comprising one or more reinforcing fibers.

15. The article of claim 1 in the form of a coextruded article, a shaped article, or a blow molded article.

16. The article of claim 1 in the form of film or a sheet.

17. The article of claim 15 in the form of a shaped article used for handling and storing fuel fluids and/or chemicals.

18. The article of claim 1 in the form of a pipe, hose, or tube.

19. The article of claim 18 in the form of a fuel line.

20. The article of claim 18 in the form of a chemical transport pipe or a district heating pipe.

21. The article of claim 18 in the form of an undersea flex pipe or marine umbilical component.
